(19) United States
(12) Patent Application Publication
(10) Pub. No.: US 2012/0167140 A1
(43) Pub. Date: Jun. 28, 2012

(54) SYSTEM AND METHOD OF PROVIDING PERSONALIZED SERVICE

(75) Inventors: Il Kyun Park, Daejeon (KR); Nac Woo Kim, Gwangju (KR); Seok Kap Ko, Gwangju (KR); Byung Tak Lee, Gyeonggi-do (KR); Sim Kwon Yoon, Gwangju (KR); Jai Sang Koh, Gwangju (KR)

(73) Assignee: ELECTRONICS AND TELECOMMUNICATIONS RESEARCH INSTITUTE, Daejeon (KR)

(21) Appl. No.: 13/333,292

(22) Filed: Dec. 21, 2011

(30) Foreign Application Priority Data
Dec. 23, 2010 (KR) 10-2010-0134031

(51) Int. Cl. H04N 21/462

(52) U.S. Cl. 725/39

(57) ABSTRACT

Provided is a mobile device for a personalized service including: a media receiving unit acquiring broadcasting contents during expressing in a broadcast viewing terminal device; and a comparing unit generating a media ID based on the broadcasting contents acquired in the media receiving unit, comparing the generated media ID with a media ID in a media ID list received from a media ID server to identify a channel ID, and transmitting a personalized service request message including the identified channel ID and a user ID to a personalized information providing server to request a personalized service.

### CROSS-REFERENCE TO RELATED APPLICATIONS

This application claims priority to and the benefit of Korean Patent Application No. 10-2010-0134031 filed in the Korean Intellectual Property Office on Dec. 23, 2010, the entire contents of which are incorporated herein by reference.

### TECHNICAL FIELD

The present invention relates to a broadcasting system, and more particularly, to a system and a method of providing a personalized service for identifying broadcasting contents which a user is watching by using a media identifier and providing the personalized service to the user.

### BACKGROUND ART

A personalized service for media broadcasting is a supplementary service for providing broadcasting contents which a user is watching and other information suitable for situations. In order to provide the supplementary service, a method for identifying the broadcasting contents is required. The methods for identifying the broadcasting contents may be various and methods for identifying the broadcasting contents in the related art are described below.

One example is a method of adding a function finding information on the contents broadcasting in a broadcasting terminal device such as a TV or a settop box (STB). However, in order to add the function, correction of the broadcasting terminal device is required. Further, a broadcasting provider has a strong tendency not to add the function for the supplementary service to his own broadcasting terminal device and it is difficult that a technology applied to one broadcasting provider is applied to another broadcasting provider.

Another example, like clear skin of KT, is a method of inserting advertisement according to a scene for each broadcasting contents in advance and transmitting the broadcasting together with the advertisement. There is a merit that the method does not need to add a contents identification function to the broadcasting terminal device. However, an auto-processing can be performed in a scene conversion recognition level when inserting an advertisement, but there is a demerit in that an area designation operation of an advertisement target for each detailed frame is manually required, which is difficult to apply a service.

Another example is a method of identifying broadcasting contents by using a media identifier ID based on an audio such as an audio fingerprint mode of Google. However, there is a demerit in that the method requires a store for analyzing the broadcasting contents in advance and extracting and storing the media ID. Further, since a function for comparing the store with the user's media ID to identify the store from the user's media ID is performed in the media ID server, there is a demerit in that a load for performing the service in the media ID server increases according to increased number of the users.

### SUMMARY OF THE INVENTION

The present invention has been made in an effort to provide a system and a method of providing a personalized service having advantages of reducing a construction cost of a media ID store and reducing a service load of a media ID server to support many users at the same time by generating a media ID for broadcasting contents during delivering in real time in the media ID server and comparing and identifying the contents in a user's mobile device instead of the media ID server.

An exemplary embodiment of the present invention provides a media identifier server including: a media ID generator receiving broadcasting contents to generate a media identifier ID; a media ID buffer storing a media ID generated in the media ID generator together with time stamp information for identifying a generation time of the media ID; and a communication unit reading a media ID of at least one channel stored in the media ID buffer to generate a media ID list and then, output the media ID list to a mobile device.

The communication unit may read a media ID of each channel stored in the media ID buffer based on current time information according to a predetermined transmission period to generate a media ID list and then, transmit the media ID list to a mobile device in a multicast form.

The communication unit may extract time information included in a media ID list request message when the media ID list request message is received from the mobile device and read a media ID of each channel from the media ID buffer based on the extracted time information to generate a media ID list and then, transmit the media ID list to the mobile device in a unicast form.

The communication unit may compare time information extracted from the media ID list request message with time stamp information stored in the media ID buffer to determine a position to read the media ID from the media ID buffer.

The media ID generator may generate one or more media ID segments based on the received broadcasting contents in real time and store time stamp information for identifying a generation time of the media ID segments together with the generated media ID segments in the media ID buffer.

The communication unit may set time stamp information of the first media ID segment as time stamp information of the media ID when the media ID is configured by collecting the media ID segments and the media ID segments configures the media ID.

In the media identifier server, the media ID segments in which a predetermined time passes may be removed from the media ID buffer in sequence.

Another exemplary embodiment of the present invention provides a method of providing a personalized service of a media identifier server, including: receiving broadcasting contents to generate a media identifier ID; storing a media ID generated in the generating step together with time stamp information for identifying a generation time of the media ID in a media ID buffer; and reading a media ID of at least one channel stored in the media ID buffer to generate a media ID list and then, output the media ID list to a mobile device.

The transmitting of the media ID list may be performed by reading a media ID of each channel from the media ID buffer based on current time information according to a predetermined transmission period to generate a media ID list and then, transmit the media ID list to a mobile device in a multicast form.

The transmitting of the media ID list may be performed by extracting time information included in a media ID list request message when the media ID list request message is received from the mobile device and reading a media ID of each channel from the media ID buffer based on the extracted time information to generate a media ID list and then, transmit the media ID list to the mobile device in a unicast form.

The transmitting of the media ID list may be performed by comparing time information extracted from the media ID list request message with time stamp information stored in the media ID buffer to determine a position to read the media ID from the media ID buffer.

The generating of the media ID may include generating one or more media ID segments based on the received broadcasting contents in real time; and storing time stamp information for identifying a generation time of the media ID segments together with the generated media ID segments in the media ID buffer.

The transmitting of the media ID list may be performed by setting time stamp information of the first media ID segment as time stamp information of the media ID when the media ID is configured by collecting the media ID segments and the media ID segments configure the media ID.

The method of providing a personalized service of a media identifier server may further include removing media ID segments in which a predetermined time passes from the media ID buffer in sequence.

Yet another exemplary embodiment of the present invention provides a mobile device including: a media receiving unit acquiring broadcasting contents during expressing in a broadcast viewing terminal device; and a comparing unit generating a media ID based on the broadcasting contents acquired in the media receiving unit, comparing the generated media ID with a media ID in a media ID list received from the media ID server to identify a channel ID, and transmitting a personalized service request message including the identified channel ID and a user ID to a personalized information providing server to request a personalized service.

The media receiving unit may include at least one of a camera and a microphone mounted on the mobile device.

Still yet another exemplary embodiment of the present invention provides a method of providing a personalized service including: acquiring broadcasting contents during expressing in a broadcast viewing terminal device to generate a media ID; comparing the generated media ID with a media ID in the media ID list received from the media ID server to identify a channel ID; and transmitting the personalized service request message including the identified channel ID and a user ID to the personalized information providing server to request a personalized service.

The method of providing a personalized service may further include transmitting a media ID list request message including time information for a media ID comparison and a user ID to the media ID server when the user inputs a request for the personalized service.

A system and a method of providing a personalized service according to exemplary embodiments of the present invention have effects as follows.

First, since a media ID is not generated in advance but generated in real time, it is possible to reduce a media ID store construction cost because a large-capacity media ID store is not required.

Second, since a media ID coordination function is distributed to a mobile device of each user instead of a media ID server (or a media ID analyzer), it is possible to support more users at the same time by reducing a service load of the media ID server.

Third, since the mobile device is used without correcting the broadcast viewing terminal device such as a TV or a settop box (STB), it is possible to solve dependency of the personalized service for a broadcasting service and to contribute to revitalizing related fusion service industries.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration block diagram illustrating an entire system for providing a personalized service according to an exemplary embodiment of the present invention.

FIG. 2 is a flowchart illustrating a method for providing a personalized service according to an exemplary embodiment of the present invention.

FIG. 3 is a detailed block diagram illustrating a media ID server according to an exemplary embodiment of the present invention.

FIGS. 4 and 5 are flowcharts illustrating a detailed operation of a communication unit according to exemplary embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention in which an object of the present invention can be implemented in detail will be described with reference to the accompanying drawings. The components and operations of the present invention illustrated in the drawings and described with reference to the drawings are described as at least one exemplary embodiment and the spirit and the core components and operation of the present invention are not limited thereto.

General terms widely used at present as possible by considering the functions in the present invention are selected as terms used in this specification, but may be changed according to purposes of those skilled in the art or customs or the appearance of new technologies. In a particular case, terms arbitrarily selected by an applicant may be used and in this case, their meanings will be described in a relevant description part of the present invention. Therefore, the terms used in this specification should be understood on the basis of practical meanings of the terms and contents throughout this specification, not only names of the terms.

A personalized service among terms used in the present invention may be a user's desired program, a target advertisement, and the like. The personalized service may be also supplementary information related to the program, for example, a summary, a preview, MP3, OST, a music video, meta data, an electronic program guide (EPG), and the like. Contents or media include all types of media such as an audio and a video.

A mobile device according to an exemplary embodiment of the present invention can bi-directionally communicate using at least one of a wire system and a wireless system and as an example, includes at least one function of a speaker and a camera. The mobile device may further include a function capable of receiving and displaying broadcasting contents. For example, the mobile device may be a portable phone. The broadcast viewing terminal device may be a TV or a settop box (STB) and may be a mobile device capable of receiving a broadcast.

In the exemplary embodiment, a media ID used for contents identification is an identifier made by analyzing features of audio and video contents and as an example, the media ID is configured in binary-number arrangement. A length of the media ID may vary according to a media ID analysis algorithm and an analysis time. A media ID list is called a set of media IDs generated for each channel.

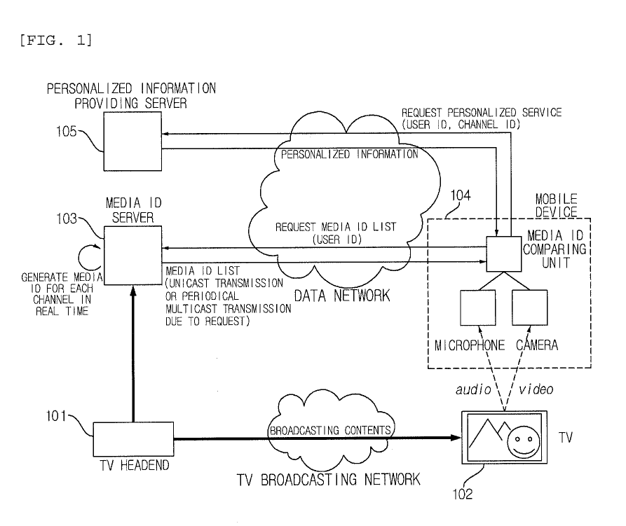

FIG. 1 is a configuration block diagram illustrating a system for providing a personalized service according to an exemplary embodiment of the present invention.

In FIG. 1, the system for providing a personalized service includes a TV headend 101, a broadcast viewing terminal device 102 expressing at least one of a speaker and a screen by receiving broadcasting contents transmitted from the TV headend 101, a media ID server 103 generating media ID from the broadcasting contents transmitted from the TV headend 101 in real-time and providing a media ID list, a mobile device 104 performing media ID coordination by using the media ID list provided from the media ID server 103, and a personalized information providing server 105 providing a personalized service to the mobile device 104 according to a request of the mobile device 104. The media ID server 103 is referred to as a media ID analyzer. The mobile device 104 includes a media receiving device, a media ID comparing unit, and a personalized service client. The media receiving device may be a camera, a microphone, and the like. The media ID comparing unit performs a request for the media ID list and a comparison of the media IDs. The personalized service client requests the personalized service to the personalized information providing server 105 and receives and processes the personalized service transmitted from the personalized information providing server 105.

In FIG. 1 configured as described above, the TV headend 101 delivers the broadcasting contents to the broadcast viewing terminal device 102 through a TV broadcasting network and simultaneously, transmits the same broadcasting contents even to the media ID server 103 in real time. The media ID server 103 generates and stores the media ID from the received broadcasting contents in real time. The media ID server 103 collects the media IDs of several channels according to the request of the user's mobile device 104 and a predetermined transmission cycle to provide the generated media ID list to the mobile device 104. In the exemplary embodiment, the media ID server 103 analyzes the features of audio and video among the broadcasting contents to generate the media ID. As an example, the media ID identifier is configured in binary-number arrangement. In this case, a length of the media ID may vary according to a media ID analysis algorithm and an analysis time.

Meanwhile, the mobile device 104 acquires sound and/or image from the broadcast viewing terminal device 102 by using the media receiving device. The media ID comparing unit of the mobile device 104 identifies a channel during viewing through a media ID generation and a comparison with the media ID list. The media ID comparing unit transmits the identified channel information and the user information to the personalized information providing server 105 and receives the personalized information requested by the user from the personalized information providing server 105.

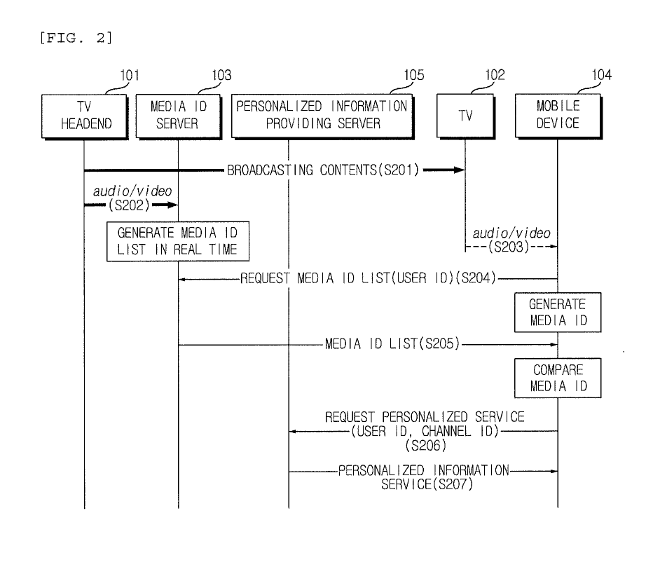

FIG. 2 is a flowchart illustrating a method for providing a personalized service according to an exemplary embodiment of the present invention.

In FIG. 2, the TV headend 101 delivers the broadcasting contents to the broadcasting viewing terminal device 102 (S201) and delivers the broadcasting contents to the media ID server 103 (S202). The media ID server 103 analyzes audio and video of the received broadcasting contents to generate a media ID in real time. That is, the media ID server 103 generates the media IDs from the received broadcasting contents for each channel in real time and collects the media IDs to manage the media IDs in a media ID list form.

When the user wants to receive a personalized service such as a target advertisement and the like during broadcast viewing, the user requests the personalized service to the mobile device 104 through a button of the mobile device 104 and other user interfaces at a desired time. Then, the mobile device 104 determines a media ID comparison start time and transmits a media ID list request message including the determined comparison start time information to the media ID server 103 to request the media ID list (S204). Simultaneously, the mobile device 104 acquires the broadcasting contents during viewing based on the comparison start time through the media receiving device (for example, a microphone and a camera) to generate the media ID (S203). In this case, the mobile device 104 acquires the broadcasting contents from the broadcast viewing terminal device 102 by using the media receiving device and then, may request the media ID list to the media ID server 103. When the mobile device 104 requests the media ID list to the media ID server 103, the mobile device 104 also transmits a user ID included in the media ID list request message. The user ID is an identifier capable of distinguishing the user's mobile device 104.

As another example of the present invention, the media ID server 103 may provide the media ID list to the corresponding mobile device 104 on a predetermined transmission period. In this case, the mobile device 104 periodically waits for the media ID list transmitted in a multicast form. The mobile device 104 acquires the broadcasting contents during viewing based on the predetermined transmission period through the media receiving device (for example, a microphone and a camera) to generate the media ID. In the exemplary embodiment of the present invention, as an example, when the media ID server 103 transmits the media ID list according to a request of the mobile device, the media ID server 103 transmits the media ID list in a unicast form and when the media ID server 103 transmits the media ID list on the predetermined transmission period, the media ID server 103 transmits the media ID list in a multicast form.

When the media ID server 103 delivers the media ID list according to a multicast transmission for each transmission period or a request of the mobile device 104 (S205), the mobile device 104 compares each media ID of the media ID list with its own media ID to identify a channel ID.

Subsequently, the mobile device 104 transmits the personalized service request message including the identified channel ID and the user ID to the personalized information providing server 105 to request the personalized service (S206).

The personalized information providing server 105 provides the personalized service suitable for information received from the mobile device 104 to the mobile device 104 (S207).

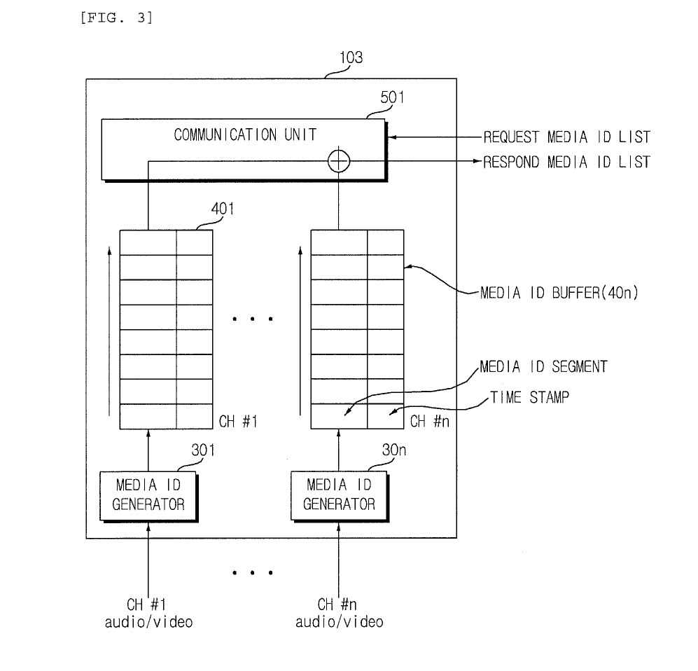

FIG. 3 is a diagram showing a structure of a media ID server 103 according to an exemplary embodiment of the present invention.

The media ID server 103 includes one or more media ID generators 301-30n analyzing audio and video of the broadcasting contents of a specific channel received from the TV headend 101 to generate the media ID, one or more media ID buffers 401-40n storing media IDs generated in each media ID generator 301-30n, and a communication unit 501 collecting the media IDs stored in the media ID buffers 401-40n when the media ID list request message is received from the mobile device 104 or the predetermined transmission period is reached to generate the media ID list and then, transmit the media ID list to the mobile device 104.

As an example, the media ID generator 301-30n and the media ID buffer 401-40n generate the media ID for each channel to store the media ID. In this case, for example, the generating and storing of the media ID may be performed in a segment unit.

As an exemplary embodiment of the present invention, generating and storing processes of a media ID will be described in detail by using one media ID generator 301 and one media ID buffer 401.

That is, when broadcasting contents of the corresponding channel are received from the TV headend 101, the media ID generator 301 of the media ID server 103 generates a media ID in real time. In this case, the media ID is generated in a segment unit. The media ID generated in the segment unit is stored together with generation time information (e.g., a time stamp) in the media buffer 401.

The media ID segment is a small-sized media ID generated for a relatively short time (1 second or less) among the contents and the media ID segment is insufficient to identify the contents due to the small size.

Accordingly, in the exemplary embodiment, a set of the media ID segments over the certain number stored in the media ID buffer 401 is referred to as a media ID. In this case, the number of minimum media ID segments for configuring the media ID varies according to a media ID analysis algorithm. When the media ID is configured by the media ID segments, as an example, time stamp information of the first media ID segment is set as time stamp information of the media ID.

Meanwhile, as an example, the media ID segments in which a predetermined time passes are removed from the media ID buffer 401 in sequence.

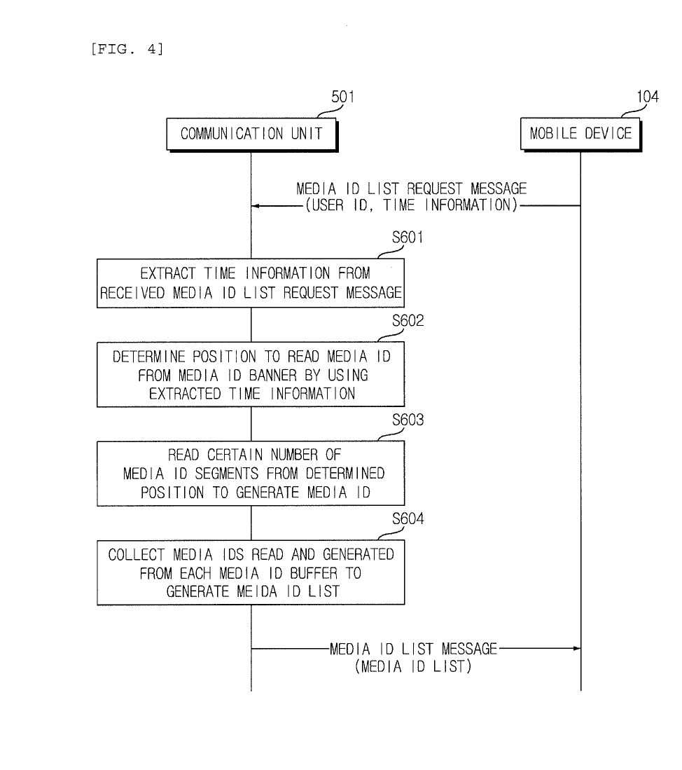

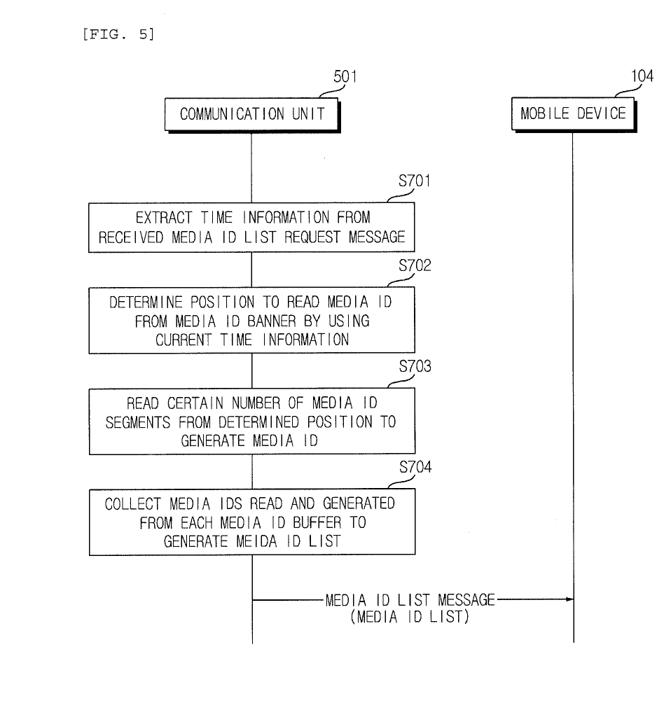

When the media ID list request message is received from the user's mobile device 104 or the predetermined transmission period is reached, the communication unit 501 generates the media ID list to transmit the media ID list to the mobile device 104 as show in FIGS. 4 and 5.

FIG. 4 is a flowchart illustrating a procedure of transmitting a media ID list message from the media ID server 103 when the media ID list request message is received from the mobile device 104 according to an exemplary embodiment of the present invention.

Referring to FIG. 4, the communication unit 501 extracts comparison start time information from the media ID list request message received from the mobile device 104 (S601).

A position (i.e., an address) where the media ID is drawn out from the media ID buffer of each channel is determined based on the extracted time information (S602). In this case, as an example, the time stamp information of each media ID segment is used as a time value for comparison with the comparison start time information of the message at the media ID buffer side.

The certain number of media ID segments is read from the position determined in the media ID buffer. The read media ID segments are collected to generate the media ID (S603).

Subsequently, the communication unit 501 collects the media IDs drawn out from the media ID buffer for each channel to generate the media ID list (S604).

The media ID list request message is transmitted to the mobile device 104 by including the media ID list in the media ID list message.

The mobile device 104 identifies the channel ID by comparing each media ID of the media ID list included in the received media ID list message with its own media ID.

Subsequently, the mobile device 104 transmits the personalized service request message including the identified channel ID and the user ID to the personalized information providing server 105 to request the personalized service. The personalized information providing server 105 provides the personalized service suitable for the information received from the mobile device 104 to the mobile device 104.

FIG. 5 is a flowchart illustrating a procedure of transmitting a media ID list message to the media ID server 103 according to a set media ID list transmission period without the media ID list request message according to an exemplary embodiment of the present invention.

That is, when a time as much as the message transmission period passes by a timer (S701), a position (that is, an address) to draw out the media ID from the media ID buffer of each channel is determined based on a current time (S702). In this case, as an example, the time stamp information of each media ID segment is used as a time value for comparison with the comparison start time information of the message at the media ID buffer side.

The certain number of media ID segments is read from the position determined in the media ID buffer. The read media ID segments are collected to generate the media ID (S703).

Subsequently, the communication unit 501 collects the media IDs drawn out from the media ID buffer for each channel to generate the media ID list (S704). The media ID list is included in the media ID list message and then, transmitted to several mobile devices in a multicast form at the same time.

When the media ID list message is received in the multicast form, the mobile device 104 identifies the channel ID by comparing each media ID of the media ID list included in the received media ID list message with its own media ID.

Subsequently, the mobile device 104 transmits the personalized service request message including the identified channel ID and the user ID to the personalized information providing server 105 to request the personalized service. The personalized information providing server 105 provides the personalized service suitable for the information received from the mobile device 104 to the mobile device 104.

As described above, the system of providing the personalized service according to the exemplary embodiment of the present invention generates the media ID in real time such that it is possible to reduce a construction cost of the media ID store because a high-capacity media ID store is not required and a media ID coordination function is distributed in each user mobile device such that it is possible to support more users at the same time by reducing a service load of the media ID server. Further, since the mobile device is used without correcting the broadcast viewing terminal device such as a TV or a settop box (STB), it is possible to solve dependency of the personalized service for a broadcasting service and to contribute to revitalizing related fusion service industries.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A media identifier server for a personalized service, comprising:
a media ID generator receiving broadcasting contents to generate a media identifier ID for each channel;
a media ID buffer storing a media ID generated in the media ID generator together with time stamp information for identifying a generation time of the media ID; and
a communication unit reading a media ID of at least one channel stored in the media ID buffer to generate a media ID list and then, output the media ID list to a mobile device.

2. The media identifier server for a personalized service of claim 1, wherein the communication unit reads a media ID of each channel stored in the media ID buffer based on current time information according to a predetermined transmission period to generate a media ID list and then, transmit the media ID list to a mobile device in a multicast form.

3. The media identifier server for a personalized service of claim 1, wherein the communication unit extracts time information included in a media ID list request message when the media ID list request message is received from the mobile device and reads a media ID of each channel from the media ID buffer based on the extracted time information to generate a media ID list and then, transmit the media ID list to the mobile device in a unicast form.

4. The media identifier server for a personalized service of claim 3, wherein the communication unit compares time information extracted from the media ID list request message with time stamp information stored in the media ID buffer to determine a position to read the media ID from the media ID buffer.

5. The media identifier server for a personalized service of claim 1, wherein the media ID generator generates one or more media ID segments based on the received broadcasting contents in real time and stores time stamp information for identifying a generation time of the media ID segments together with the generated media ID segments in the media ID buffer.

6. The media identifier server for a personalized service of claim 5, wherein the communication unit sets time stamp information of the first media ID segment as time stamp information of the media ID when the media ID is configured by collecting the media ID segments and the media ID segments configures the media ID.

7. The media identifier server for a personalized service of claim 5, wherein the media ID segments in which a predetermined time passes are removed from the media ID buffer in sequence.

8. A method of providing a personalized service of a media identifier server, comprising:
receiving broadcasting contents to generate a media identifier ID for each channel;
storing a media ID generated in the generating step together with time stamp information for identifying a generation time of the media ID in the media ID buffer; and
reading a media ID of at least one channel stored in the media ID buffer to generate a media ID list and then, output the media ID list to a mobile device.

9. The method of providing a personalized service of a media identifier server of claim 8, wherein the transmitting of the media ID list is performed by reading a media ID of each channel from the media ID buffer based on current time information according to a predetermined transmission period to generate a media ID list and then, transmit the media ID list to a mobile device in a multicast form.

10. The method of providing a personalized service of a media identifier server of claim 8, wherein the transmitting of the media ID list is performed by extracting time information included in a media ID list request message when the media ID list request message is received from the mobile device and reading a media ID of each channel from the media ID buffer based on the extracted time information to generate a media ID list and then, transmit the media ID list to the mobile device in a unicast form.

11. The method of providing a personalized service of a media identifier server of claim 10, wherein the transmitting of the media ID list is performed by comparing time information extracted from the media ID list request message with time stamp information stored in the media ID buffer to determine a position to read the media ID from the media ID buffer.

12. The method of providing a personalized service of a media identifier server of claim 8, wherein the generating of the media ID includes
generating one or more media ID segments based on the received broadcasting contents in real time; and
storing time stamp information for identifying a generation time of the media ID segments together with the generated media ID segments in the media ID buffer.

13. The method of providing a personalized service of a media identifier server of claim 12, wherein the transmitting of the media ID list is performed by setting time stamp information of the first media ID segment as time stamp information of the media ID when the media ID is configured by collecting the media ID segments and the media ID segments configures the media ID.

14. The method of providing a personalized service of a media identifier server of claim 12, further comprising: removing media ID segments in which a predetermined time passes from the media ID buffer in sequence.

15. A mobile device for a personalized service, comprising:
a media receiving unit acquiring broadcasting contents during expressing in a broadcast viewing terminal device; and
a comparing unit generating a media ID for each channel based on the broadcasting contents acquired in the media receiving unit, comparing the generated media ID with a media ID in a media ID list received from the media ID server to identify a channel ID, and transmitting a personalized service request message including the identified channel ID and a user ID to a personalized information providing server to request a personalized service.

16. The mobile device for a personalized service of claim 15, wherein the media receiving unit includes at least one of a camera and a microphone mounted on the mobile device.

17. A method of providing a personalized service of a mobile device, comprising:
acquiring broadcasting contents during expressing in a broadcast viewing terminal device to generate a media ID for each channel;
comparing the generated media ID with a media ID in the media ID list received from a media ID server to identify a channel ID; and
transmitting the personalized service request message including the identified channel ID and a user ID to the personalized information providing server to request a personalized service.

18. The method of providing a personalized service of a mobile device of claim 17, further comprising:
transmitting a media ID list request message including time information for a media ID comparison and a user ID to the media ID server when the user inputs a request for the personalized service.
